(19) United States
(12) Patent Application Publication
(10) Pub. No.: US 2010/0215502 A1
(43) Pub. Date: Aug. 26, 2010

(54) MULTISTAGE WIND TURBINE WITH VARIABLE BLADE DISPLACEMENT

(75) Inventor: Howard Robert Harrison, Mississauga (CA)

Correspondence Address: Distributed Thermal Systems, 2150 Winston Park Drive, Suite 106, Oakville, ON, L6H 5VI, CA

(73) Assignee: DISTRIBUTED THERMAL SYSTEMS LTD., Oakville, ON (CA)

(21) Appl. No.: 12/450,475

(22) PCT Filed: Mar. 31, 2008
(86) PCT No.: PCT/CA2008/000587

§ 371 Date: Sep. 26, 2009

Related U.S. Application Data
(60) Provisional application No. 60/909,413, filed on Mar. 30, 2007.

(51) Int. Cl. B64C 11/06; F03D 9/00

(52) U.S. Cl. 416/205; 290/55

(57) ABSTRACT

A multiple rotor wind turbine, having variable angular and/or axial displacements between the two or more rotors. The variation in angle and axial displacement between the rotors (and the corresponding turbine blades affixed to said rotors) control the torque characteristics of the turbine at varying wind speeds.

### FIELD OF INVENTION

The present invention relates to the field of multistage wind turbines.

### BACKGROUND OF INVENTION

Wind turbines have become an acceptable source of green energy; however current designs have a few drawbacks that are preventing more widespread use.

These include large size, which some consider unsightly, variable turbine speeds, and noise. At the root of these problems is a less than ideal conversion of the wind's kinetic energy to the rotation of the turbine blade. If this conversion could be made more efficient, then the blade could be made smaller, resulting in smaller towers, lower blade tip speeds and reduced noise. Conversely, a blade with the same diameter could produce more electrical power. Further, a turbine with a variable response to wind speed could be controlled to rotate at a more constant speed under variable wind conditions.

It is commonly known in the art that the torque produced by a wind turbine may be increased by increasing the number of blades.

Much of the focus in prior art has been on different types of wind turbines, or the optimization of a particular component. U.S. Pat. No. 7,347,660 describes an improved type of vertical axis turbine. U.S. Pat. No. 7,344,360 focuses on blade design for single rotor horizontal axis wind turbines and claims blades with variable in plane sweep. U.S. Pat. No. 7,335,128 describes an improved transmission design for horizontal axis wind turbines. U.S. Pat. No. 7,331,761 describes an improved pitch bearing for horizontal axis wind turbine blades. U.S. Pat. No. 7,293,959 describes a lift regulating means for independent blades on a horizontal axis wind turbine rotor.

Other inventors have taught multiple rotors, but none have considered mounting them on the same axis with variable angular and/or axial displacements, to control the torque characteristic of the combined virtual blades. U.S. Pat. No. 7,299,627 addresses the destructive impact that the wind shadow of an upstream rotor has on a downstream rotor, in a wind farm situation, but does not anticipate the constructive benefits of mounting an upstream rotor and a downstream rotor on the same shaft. U.S. Pat. No. 6,713,893 discloses a first rotor and a second rotor, on different shafts, each on a different axis, and a combined generator to generate electrical energy when the field rotors rotate relative to each other. U.S. Pat. No. 6,504,260 teaches two counter-rotating rotors, each connected to a separate shaft and hub, each on a different axis, with both connected to common generator system that allows for improved load control. U.S. Pat. No. 6,278,197 teaches two counter-rotating rotors, mounted at opposite ends of a generator, coaxially on an inner and an outer shaft, such that the wind induced counter-rotation of the two shafts creates electrical energy due to the generator components mounted there between.

### BRIEF DESCRIPTION OF THE DRAWINGS

FIG. 1 presents a front view of a multi-stage wind turbine with three virtual blades,

FIG. 2 presents a side view of a multi-stage wind turbine with three virtual blades,

FIG. 3 presents results from a multi-stage wind turbine with three virtual blades test,

FIG. 4 depicts a front view of a multi-mode wind turbine in a one virtual blade mode,

FIG. 5 depicts a multi-mode wind turbine in a three blade mode, and

FIG. 6 presents a side view of a multi-stage wind turbine with an aerodynamic shroud.

### SUMMARY OF THE INVENTION

According to one aspect of the present invention is a wind turbine blade assembly for a wind turbine, comprising a front rotor having at least one front blade; a rear rotor having at least one rear blade; wherein an angular displacement between the front blade and the rear blade is adjustable, and the front rotor and the rear rotor are configured to rotate in the same direction when the wind turbine is in operation.

In one embodiment, the angular displacement between the front blade and the rear blade is adjustable between an angle of −15 degrees and an angle of +15 degrees.

In a further embodiment, the angular displacement between the front blade and the rear blade is adjustable while the wind turbine is in operation.

In yet a further embodiment, an axial displacement between the front blade and the rear blade is adjustable.

According to a further aspect of the present invention is a wind turbine blade assembly for a wind turbine, comprising: a front rotor having at least one front blade; a rear rotor having at least one rear blade; wherein an axial displacement between the front blade and the rear blade is adjustable, and the front rotor and the rear rotor are configured to rotate in the same direction when the wind turbine is in operation.

In a further embodiment, the axial displacement is adjustable by 10% of the rotor diameter.

In a further embodiment, the axial displacement is adjustable while the wind turbine is in operation.

In yet a further embodiment, the front rotor has three front blades mounted at 120 degree intervals, and the rear rotor has three rear blades mounted at 120 degree intervals.

In yet a further embodiment, the wind turbine blade assembly further comprises an intermediate rotor having at least one intermediate blade, wherein the front rotor and the intermediate rotor are configured to rotate in the same direction when the wind turbine is in operation.

In yet a further embodiment, an intermediate angular displacement between the front blade and the intermediate blade is adjustable.

In yet a further embodiment, an intermediate axial displacement between the front blade and the intermediate blade is adjustable.

In yet a further embodiment, the intermediate angular displacement between the front blade and the intermediate blade is adjustable between an angle of −15 degrees and an angle of +15 degrees.

In yet a further embodiment, the intermediate angular displacement between the front blade and the intermediate blade is adjustable while the wind turbine is in operation.

In yet a further embodiment, the intermediate axial displacement is adjustable by 10% of the rotor diameter.

In yet a further embodiment, the intermediate axial displacement is adjustable while the wind turbine is in operation.

In yet a further embodiment, the wind turbine blade assembly further comprises a front counter-ballast located on the front rotor at 180 degrees to the front blade.

In yet a further embodiment, the wind turbine blade assembly further comprises a rear counter-ballast located on the rear rotor at 180 degrees to the rear blade.

In yet a further embodiment, the wind turbine blade assembly further comprises an intermediate counter-ballast located on the intermediate rotor at 180 degrees to the intermediate blade.

In yet a further embodiment, the angular displacement and the axial displacement between the front blade and the rear blade can be adjusted such that both approach 0 and the front blade and the rear blade have a combined aerodynamic effect of a single blade.

In yet a further embodiment, the angular displacement and the axial displacement between the front blade, the rear blade, and the intermediate blade, can be adjusted such that they all approach 0 and the front blade, the rear blade, and the intermediate blade have a combined aerodynamic effect of a single blade.

In yet a further embodiment, the angular displacement between the front blade, the rear blade, and the intermediate blade, can be adjusted such that they all approach 120 degrees, and the front blade, the rear blade, and the intermediate blade have a combined aerodynamic effect of a three blade, single rotor blade assembly.

A further aspect of the present invention is a wind turbine having the wind turbine blade assembly as described above.

In one embodiment, the wind turbine has the front rotor mounted on an inner shaft and the rear rotor mounted on an outer shaft, wherein the inner shaft and the outer shaft are co-axial such that the inner shaft and the outer shaft can be rotated with respect to one another.

In a further embodiment, the wind turbine further comprises an adjustable hub, that allows the front rotor to be rotated with respect to the rear rotor or the rear rotor to be rotated with respect to the front rotor; a brake system, that allows the adjustable hub to be affixed in position such that the front rotor and the rear rotor do not rotate with respect to one another.

In yet a further embodiment, the wind turbine further comprises a linear actuator affixed to a distal end of the inner shaft, wherein the linear actuator is configured to push the inner shaft and front rotor to increase axial displacement between the front rotor and the back rotor, and to pull the inner shaft and front rotor to decrease axial displacement between the front rotor and the back rotor.

In yet a further embodiment, the wind turbine further comprises a shaft brake attached to the inner shaft, said shaft brake, when activated, allowing the inner shaft to be in locked rotation with the outer shaft, and, when released, allowing the inner shaft to rotate freely from said outer shaft.

In yet a further embodiment, the wind turbine further comprises a position sensor capable of monitoring the relative rotational position of the inner shaft with respect to the outer shaft to facilitate control of angular displacement.

In yet a further embodiment, the wind turbine further comprises an aerodynamic shroud.

In a further embodiment, the aerodynamic shroud is configured as a large scale nozzle.

In a further embodiment, the aerodynamic shroud comprises a nose cone, at least one support strut and at least one stator strut, said support strut configured to be integrated with said nose cone.

In a further embodiment, the aerodynamic shroud is configured to contain the blades in the event of a blade detachment.

In a further embodiment, the blades are configured with permanent magnets and the aerodynamic shroud is configured with multiple generator poles, wherein the generator poles are selectively responsive to the rotation of the blades to generate electrical current.

In a further embodiment, the axial and angular displacements are pre-set for an average wind condition.

In a further embodiment, the wind turbine further comprises a set of splines or a set of cams, configured to create a fixed set of angular and axial displacement parameters.

### DETAILED DESCRIPTION

The current inventor has discovered that the amount of incremental torque produced by the additional blades may be adjusted by changing the positions of the additional blades relative to the original blades. The relative positions of the blades may be controlled in this manner to produce a higher turbine rpm in low speed winds, and a lower turbine rpm in high wind speeds. It follows that the relative positions of the blades may be controlled to produce a more consistent turbine rpm in variable wind speed conditions. This will ease the task of producing constant frequency AC power in variable wind speed conditions. Further, the ability to produce more torque from smaller blades will allow for the construction of smaller turbines with slower blade tip speeds, thereby reducing mass, cost, and acoustic noise.

The above describes a configuration where the relative positions of the blades may be adjusted in real time to compensate for variable wind conditions. Alternatively, the relative positions of the blades may be preset to suit the average wind conditions of a given location. This would be much simpler and less expensive than designing a new set of turbine blades to suit localized wind conditions, hence making low average wind speed locations much more economically feasible.

The current inventor teaches that the relative position of two adjacent blades may be described using two basic parameters; axial displacement and angular displacement. Axial displacement may be defined as the distance between an upstream blade and a downstream blade, as measured along the turbine shaft. Angular displacement may be defined as the degree to which a downstream blade leads an upstream blade in the direction of rotation. The blades may be of the same or different composition and/or geometry, to produce the most ideal combined aerodynamic and acoustic qualities.

Multiple blades may be on two or more rotors to facilitate the control process. Further, the rotors may be mounted co-axially, on independent shafts, such that the relative position of one rotor may be changed with respect to the other rotor, hence changing the relative positions of the blades that are mounted on the rotors. In this case axial displacement may be defined as the distance between an upstream and an adjacent downstream rotor, as measured along the turbine shaft, and angular displacement may be defined as the degree to which a downstream rotor leads an adjacent upstream rotor in the direction of rotation.

In a two rotor configuration each rotor may have three blades mounted at 120 degree intervals, with each rotor resembling a traditional three blade rotor as seen on most wind turbines today. It has been determined by testing this type of configuration in constant wind speed conditions that turbine speed may be increased with negative angular displacement, to a maximum, and that turbine speed may be decreased with positive angular displacement, to a minimum. Further, it has been determined that turbine speed may by increased with larger axial displacements, to a maximum, and decreased with smaller axial displacements, to a minimum. The required variations in angular and axial displacements are slight, with test results confirming that a +/−7.5 degree variation in angular displacement combined with a 2″ change in axial displacement, for a nominal rotor diameter of 6′, will cause the turbine speed to change by almost 20%.

Surprisingly, the turbine speed for a two rotor configuration, with each rotor having three blades mounted at 120 degree intervals, is also higher than that of an equivalent single rotor turbine when the angular displacement is 0 degrees. This may be because the two blades are acting as a type of “bi-plane” wing, creating more lift for the same apparent wind. When viewed from this perspective, the concept of changing the angular displacement may be visualized as a type bi-plane wing where the top aerofoil may be moved back and forth with respect to the bottom aerofoil, thus adjusting the lift and drag characteristics of the combined turbine blades. Further, the concept of changing the axial displacement may be visualized as a type of bi-plane wing where the top aerofoil may be moved upwards or downwards, taking it farther away from or bringing it closer to the bottom aerofoil, thus adjusting the lift and drag characteristics of the combined turbine blades. Further, it should be noted that the direction of the apparent wind may be made more favourable, especially at low rpm, by pointing the axis of the turbine away from the wind. This technique may be used to increase torque at start-up.

The combined turbine blades referenced above may be considered as a type of virtual turbine blade that has adjustable aerodynamic characteristics. Thus a two rotor configuration, with each rotor have three blades at 120 degree intervals, may be viewed as a type of traditional single rotor turbine that has three adjustable virtual blades. This approach may allow the use of existing design tools, such as CFD models, to be applied to the design of multi-stage wind turbines.

In another implementation the multi-stage wind turbine may be configured with three rotors each having one turbine blade. Further, each turbine blade may be configured with a counter-ballast located at 180 degrees to the blade, to provide balance. In this case the three blades may be located at an angular displacement of zero (0) degrees with respect to each other, or at very small angular displacements with respect to each other, and with variable axial displacements, to create a type of multi-stage wind turbine that has a single adjustable virtual blade. Further, the same three blades may be alternatively located at relative angular displacements of 120 degrees to change the same multi-stage wind turbine into one that has three adjustable virtual blades. The single virtual blade mode offers reduced solidity for the same swept area, thus increasing the potential turbine speed. The three virtual blade mode would increase the solidity but also increase the potential torque provided by the wind turbine. The counter-ballasts, which may also be designed to contribute to the overall aerodynamics, may add balance to the configuration in the single virtual blade mode, the three virtual blade mode, and while moving between the two modes.

In some implementations, designed to withstand very high wind speeds or gusts, the rotors and blades may be designed such that the blades may be nested together with no axial displacement. Further, the upstream blade(s) may be larger than the downstream blade(s), such that the downstream blade(s) are completely within the wind shadow of the upstream blade(s), thereby negating any bi-plane effect and causing the combined virtual blade to act as a traditional single blade.

The invention also teaches that an aerodynamic shroud that may be configured around the perimeter of the multi-stage wind turbine blades, such that it controls and accelerates the airflow as it passes through the multi-stage wind turbine. The aerodynamic shroud may also be configured to reduce acoustic noise, and to reduce the damage caused by blades that may become disassociated with the hub. The support structure for the aerodynamic shroud may be configured as a stator blade, to control and optimize the wind and the wake produced by the upstream rotor such that it increases the performance of the downstream rotor. Further, the support structure for the aerodynamic shroud may also be configured to act as a heat sink, providing cooling for the generator or other components that may be located on the hub area.

In an alternative implementation the aerodynamic shroud may also be configured as a generator that responds to the rotation of the turbine blade tips. In this case the generator/aerodynamic shroud may contain multiple poles, selectively operational at various turbine speeds to produce relatively constant frequency AC power under variable wind conditions, or to produce a braking effect under adverse wind conditions.

### Examples of Preferred Embodiments

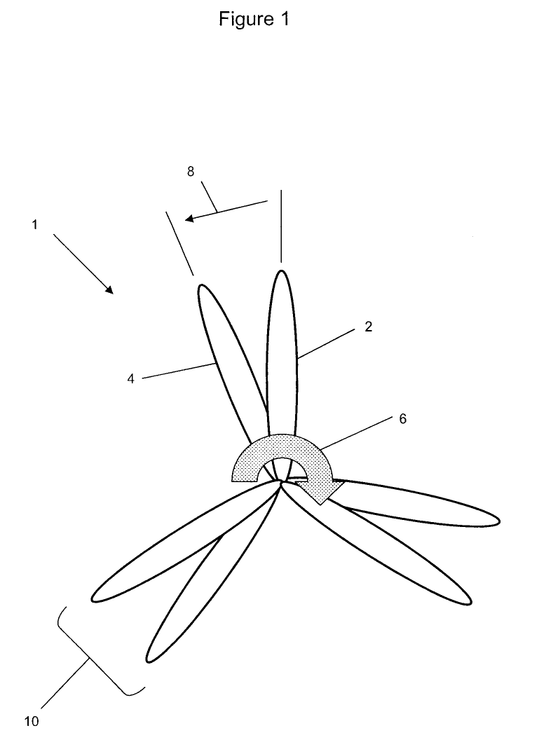

FIG. 1 presents a front view of multi-stage wind turbine 1 configured with two three blade rotors; upstream rotor 2 and downstream rotor 4. Upstream rotor 2 and downstream rotor 4 may be aerodynamically designed to interact with the wind such that multi-stage wind turbine 1 rotates in a clockwise direction, as shown by rotational arrow 6. The blades on upstream rotor 2 and downstream rotor 4 are separated by angular displacement 8, which may be defined as negative when downstream rotor 4 lags behind upstream rotor 2 as multi-stage wind turbine 1 rotates in the indicated direction.

The torque produced by multi-stage wind turbine 1 may be modified by changing angular displacement 8. It has been found that small positive and negative changes in angular displacement 8, about the position where angular displacement 8 is zero (0) degrees, cause relatively large changes in the torque produced by multi-stage wind turbine 1. This simplifies the mechanism required to change angular displacement 8 since a limited range of motion will produce the desired effect. Changing angular displacement 8 beyond a certain range becomes counter-productive, i.e. the torque produced by multi-stage wind turbine 1 reaches a maximum at one angular displacement 8 and a minimum at another angular displacement 8 and adjustments beyond these points will cause multi-stage wind turbine to produce less torque or more torque, respectively.

Multi-stage wind turbine 1 may be configured to allow for a change in angular displacement 8 by mounting upstream rotor 2 and downstream rotor 4 on two coaxial shafts such that one shaft may be rotated with respect to the other, by mounting upstream rotor 2 and downstream rotor 4 on the same shaft but with at least one adjustable hub that allows the controlled rotor(s) to be rotated with respect to the shaft, or through some other means. Alternatively multi-stage wind turbine 1 may be configured with a fixed angular displacement 8 that has been predetermined and preset to optimize the performance of multi-stage wind turbine 1 for local wind conditions.

It should be noted that an angular displacement 8 of positive sixty (+60) degrees is the same as an angular displacement 8 of negative sixty (−60) degrees with respect to the next adjacent blade of upstream rotor 2, at least in this configuration of multi-stage wind turbine 1 where upstream rotor 2 and downstream rotor 4 each have three similar blades located at 120 degree intervals. It follows that angular displacement 8 is cyclical, always varying from a minimum of negative sixty (−60) degrees to a maximum of positive sixty (+60) degrees as one rotor is allowed to rotate with respect to the other. Thus a change from a negative angular displacement 8 to a positive angular displacement 8 may be accomplished by rotating downstream rotor 4 clockwise or counter-clockwise with respect to upstream rotor 2, or visa versa.

Knowledge of this cyclical characteristic of angular displacement 8 may simplify the mechanism and process required to control angular displacement 8, since the torque required to rotate one rotor clockwise with respect to the other, while multi-stage wind turbine 1 is rotating clockwise, may be substantially less than that required to rotate the same rotor in the opposite direction. The adjustment may be accomplished by configuring one controlled rotor with a hub and a brake, such that the controlled rotor may selectively rotate at different speeds than the shaft, while the other rotor remains attached to the shaft. The brake may be eased to temporarily reduce the load on the controlled rotor, thus allowing the controlled rotor to rotate slightly faster than the shaft for a brief period of time, and then re-applied to secure the controlled rotor at a new angular displacement 8. Further, the brake may be generally used to adjust the load on the controlled rotor, thus allowing for some adjustment of the overall load on multi-stage wind turbine 1 under adverse conditions.

The torque produced by multi-stage wind turbine 1 when downstream rotor 4 is directly behind upstream rotor 2, i.e. when angular displacement 8 is zero (0) degrees, may still be greater than the torque produced by a single rotor wind turbine configured with a rotor that is similar to upstream rotor 2. This is because downstream rotor 4 may be located at a distance behind upstream rotor 2, and their respective blades continue to interact with the wind in a combined manner to produce the incremental torque. The effect is similar to that of the enhanced lift provided by a biplane wing, especially when one considers that the apparent wind, as it acts on the rotating blades, enters the combined blade configuration at an angle that is much more parallel to the plane swept by the blades than does the actual wind. In configurations where this is not desirable, the blades of the downstream rotor may be designed to nest into the blades of upstream rotor such that the combined aerodynamic characteristics are virtually the same as that of the upstream rotor alone, when the angular displacement is zero (0) degrees.

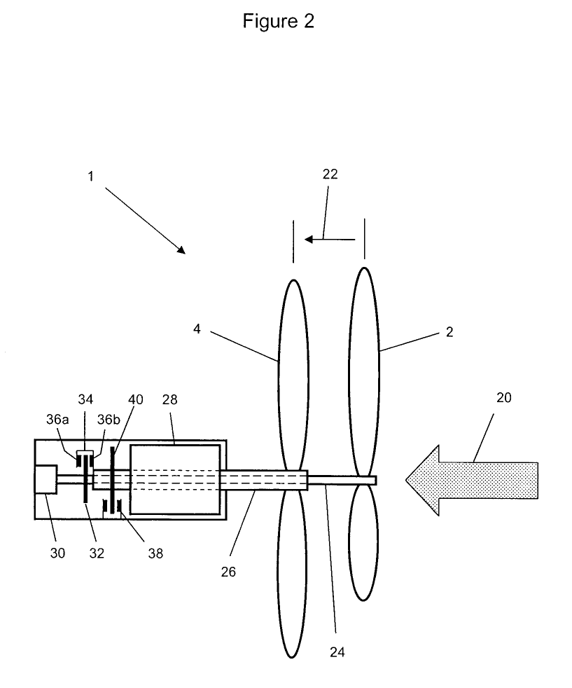

The combined aerodynamic characteristics of a pair of blades at any given angular displacement 8, with one blade of the pair being from upstream rotor 2 and the other blade of the pair being from downstream rotor 4, may be considered equivalent to that of a single virtual blade 10. Clearly the aerodynamic characteristics of virtual blade 10 will change as adjustments are made to angular displacement 8 and axial displacement 20 (reference FIG. 2). However the ability to consider it as a single virtual blade 10, with modifiable aerodynamic characteristics, may allow for the use of existing single rotor wind turbine software models and design tools to expedite the further design and optimization of multi-stage wind turbine 1.

Multi-stage wind turbine 1 may also be configured with other features such as rotors with blades of different composition and design, rotors with blades of different sizes, rotors with more or less than three blades, rotors with variable pitch, more than three rotors, and so on, to achieve the range of aerodynamic characteristics and acoustic qualities that are desired for a particular application.

FIG. 2 presents a side view of multi-stage wind turbine 1 with wind 20. Upstream rotor 2 may be mounted coaxially with downstream rotor 4, at an axial displacement 22 with respect to downstream rotor 4. Upstream rotor 2 may be attached to inner shaft 24 and downstream rotor 4 may be attached to outer shaft 26. Inner shaft 24 may be configured to normally rotate with and yet slide coaxially within outer shaft 26, allowing for changes in axial displacement 22 while allowing both upstream rotor 2 and downstream rotor 4 to remain in mechanical communication with generator 28.

The torque produced by multi-stage wind turbine 1 may be modified by changing axial displacement 22. It has been found that small positive and negative changes in axial displacement 22, about a nominal axial displacement 22, cause relatively large changes in the torque produced by multi-stage wind turbine 1. This simplifies the mechanism required to change axial displacement 22 since a limited range of motion will produce the desired effect. Changing axial displacement 22 beyond a certain range may become counter-productive, i.e. the torque produced by multi-stage wind turbine 1 may reach a maximum at one axial displacement 22 and a minimum at another axial displacement 22 and adjustments beyond these points may cause multi-stage wind turbine 1 to produce less torque or more torque, respectively.

It has been found that the range of torque produced by multi-stage wind turbine 1, at a constant wind speed, may be further extended by combining changes in axial displacement 22 with changes in angular displacement 8 (reference FIG. 1). It follows that combining changes in axial displacement 22 with changes in angular 8 will allow multi-stage turbine 1 to deliver constant torque over an extended range of wind speeds. Axial displacement 22 and angular displacement 8 may be changed simultaneously in the following manner.

Axial displacement 22 may be changed as follows. Inner shaft 24 may be configured to extend through outer shaft 26 such that it protrudes beyond the end of outer shaft 26 and into linear actuator 30. Linear actuator 30 may be configured to push inner shaft 24 and upstream rotor 2 into the wind to increase axial displacement 22, and to pull inner shaft 24 and upstream rotor 2 away from the wind to decrease axial displacement 22, within a pre-determined range of axial displacements 22, and when required to adapt to changing wind conditions.

Angular displacement 8 (reference FIG. 1) may be simultaneously changed as follows. Inner shaft 24 may be configured with shaft brake disk 32, slidingly attached to inner shaft 24 with a spline shaft or some other mechanism that allows inner shaft 24 to be in locked rotation with, and yet slide within, shaft brake disk 32. Shaft brake disk 32 may be configured to be normally retained within shaft brake housing 34, which is attached to outer shaft 26, such that inner shaft 24 may normally be in locked rotation with outer shaft 26, and such that the combined torque from both shafts may be simultaneously delivered to generator 28. Shaft brake pads 36a and 36b, shown here in the open position for illustrative purposes only, may be configured to be normally pressed against brake disk 32 to accomplish the required braking and shaft locking function. However, when it is necessary to change angular displacement 8, shaft brake pads 36a and 36b may be pulled away from brake disk 32, allowing upstream rotor 2 to rotate faster than downstream rotor 4 until a new angular displacement 8 has been reached, as previously described.

The use of a normally on configuration for shaft brake pads 36a and 36b has several advantages, including but not limited to; (i) it requires less power since power need only be applied when the shaft brake disk 32 has to be partially or fully released and (ii) in failure mode the brake pads will continue to retain shaft brake disk 32, thereby ensuring that multi-stage wind turbine 1 continues to operate, albeit at a potentially less than optimum level.

Various other means are also available to control axial displacement 22 and angular displacement 8 (reference FIG. 1). If, for example, it is found that the torque produced by multi-stage wind turbine 1 may be best controlled by associating a particular angular displacement 8 with each axial displacement 22, then inner shaft 24 may be configured with splines or cams, slidingly attached to mating splines or cams on the inside of outer shaft 26, such that the splines or cams will direct inner shaft 24 to a particular angular displacement 8 for each axial displacement 22. The splines or cams will automatically respond to changes in axial displacement 22, produced by linear actuator 30, in this manner.

Multi-stage wind turbine 1 may also be configured with main brake assembly 38 to prevent upstream rotor 2 and downstream rotor 4 from turning under severe wind conditions. Main brake assembly 38, in this case configured as a normally off brake, when actuated, will operate on main brake disk 40 to stop outer shaft 26 and downstream rotor 4 from rotating, and, providing that shaft brake assembly is in the normally on position, also stop inner shaft 24 and upstream rotor 2 from rotating. Alternatively, in order to prevent an excessive load on main brake assembly 38, shaft brake assembly 34 may be partially or fully actuated before main brake assembly 38 is applied. This will allow inner shaft 24 and upstream rotor 2 to continue rotating until outer shaft 26 and downstream rotor 4 have come to a full stop, at which time shaft brake assembly 34 may be released to the normally on position again to stop the rotation of inner shaft 26 and upstream rotor 2. In some larger applications multiple brake disks and brake assemblies may be configured, in this manner, to provide the necessary braking power.

Shaft brake assembly 34 and shaft brake disk 32 may be configured with position sensors to monitor the relative rotational position of inner shaft 24 with respect to outer shaft 26, which corresponds to the relative rotational position of upstream rotor 2 with respect to downstream rotor 4, to facilitate the control of angular displacement 8 (reference FIG. 1). Also, main brake assembly 38 and main brake disk 40 may be configured with sensors to monitor the rotational speed of outer shaft 26 and downstream rotor 4, which corresponds to the rotational speed of generator 28, for turbine speed control and other purposes. Various other means are also available to monitor the rotational speed of generator 28, angular displacement 8, axial displacement 22, and other parameters associated with multi-stage wind turbine 1.

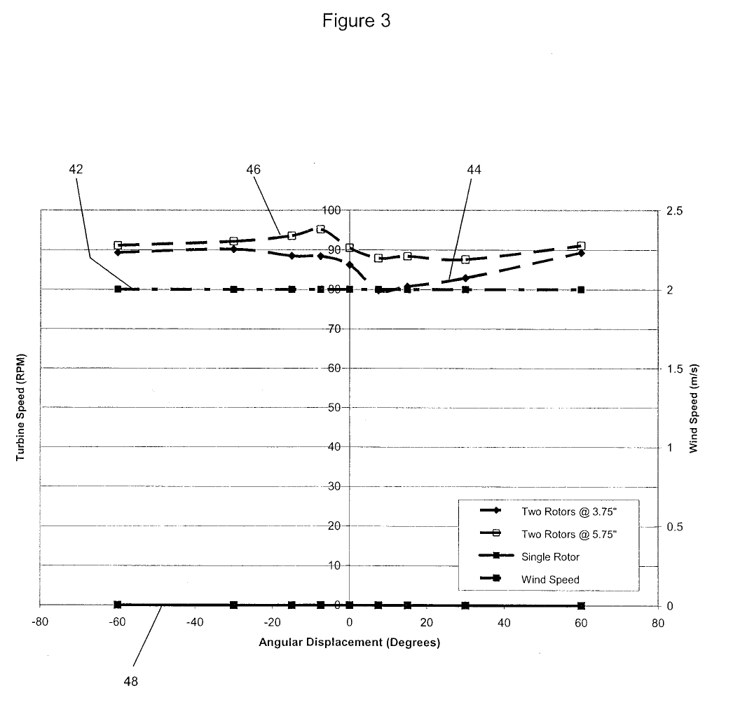

FIG. 3 presents results from a test of multi-stage wind turbine 1 (reference FIG. 2) having two similar three blade rotors, each with a nominal rotor diameter of 2 meters. The test was completed at a constant wind speed of 2 m/s in order to confirm that the turbine speed could be changed by varying the axial and angular displacements, and to determine what range of control would be required to create the largest possible change in turbine speed, under these conditions. It should be noted that the achievable changes in turbine speed and the required range of control over axial and angular displacements may change as wind speed increases and as other parameters, such as blade design and rotor diameter are modified.

Wind speed was retained at a constant 2 m/s throughout the test as documented by wind speed line 42, with reference to the dash-dot data line with the solid square markers and the right hand “Y” axis. The “wind” was produced in a controlled environment by an array of nine industrial fans with outlet baffles, calibrated to produce the required average wind speed.

In the first test the multi-stage wind turbine was configured with an upstream and a downstream rotor at an axial displacement of 3.75″, and with an adjustable hub that allowed the angular displacement to be adjusted in 7.5 degree increments. The results are recorded by two rotors at 3.75″ rpm line 44, with reference to the dashed data line with the solid square markers and the middle “Y” axis. Turbine speed was approximately 90 rpm at an axial displacement of −60 degrees, fell to a minimum of approximately 80 rpm at an angular displacement of +7.5 degrees, and then rose back up to the 90 rpm level at an angular displacement of +60 degrees, which, as has been previously noted, corresponds to an angular displacement of −60 degrees with respect to the next blade on the other rotor. These results confirm that the torque produced by a multi-stage wind turbine, and therefore the turbine speed under a given load, may be changed by adjusting the angular displacement at constant axial displacement and wind speed.

The fundamental difference between the first test and the second test was that the axial displacement was increased from 3.75″ to 5.75″, i.e. an increase of only 2.00″. The results are recorded on the two rotors at 5.75″ rpm line 46, with reference to the dashed data line with open square markers and the middle “Y” axis. It should be noted that every point on two rotors at 5.75″ rpm line 46 is above two rotors at 3.75″ line 44, hence we can conclude that the torque produced by a multi-stage wind turbine, and therefore the turbine speed under a given load, may be changed by adjusting the axial displacement at constant angular displacement and wind speed.

It should also be noted that there is a distinct peak of approximately 95 rpm in the two rotors at 5.75″ line 46, at a −7.5 degree angular displacement. This peak, when combined with the distinct valley of approximately 80 rpm in the two rotors at 3.75″ line 44, at a +7.5 degree angular displacement, illustrates that turbine speed may be increased by 15 rpm, or approximately 19% of the lower speed, by increasing axial displacement by 2.00″ while reducing angular displacement by 15 degrees. Further, it should be noted that the change in angular displacement is from +7.5 degrees to −7.5 degrees, i.e. symmetrical about and close to the zero (0) degrees angular displacement or “aligned blade” configuration. Hence it can be concluded that small changes in the angular and axial displacements produce relatively large changes in turbine speed.

The third test was substantially different, in that the upstream rotor and adjustable hub were removed to leave only one single downstream rotor with three blades. Hence the third test reflects the performance of a traditional single rotor/three blade wind turbine under the same controlled wind speed of 2 m/s. Surprisingly the reconfigured turbine did not even rotate, as indicated by single blade line 48, with reference to the solid black line with solid square markers at the bottom of the chart, and the middle “Y” axis. Hence it may be concluded that the multi-stage wind turbine configuration outperforms a single rotor traditional turbine, since the multi-stage wind turbine turned at speeds of 80 to 95 rpm under the same wind conditions.

The zero (0) degree angular displacement results are of particular interest, since the multi-stage wind turbine continues to rotate even when the blades of downstream rotor are “parked” immediately behind the blades of the upstream rotor and one might initially think that the configuration would operate as a single rotor turbine. However the two blades operate more as a type of “bi-plane” wing, producing the extra torque required to spin the turbine. Further, it can be noted from the results that this effect is more pronounced at an axial displacement of 5.75″ than it is for and axial displacement of 3.75″, since the multi-stage wind turbine rotates faster at the former than the latter.

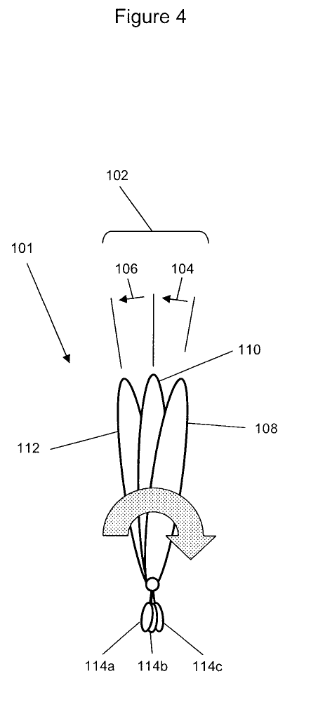

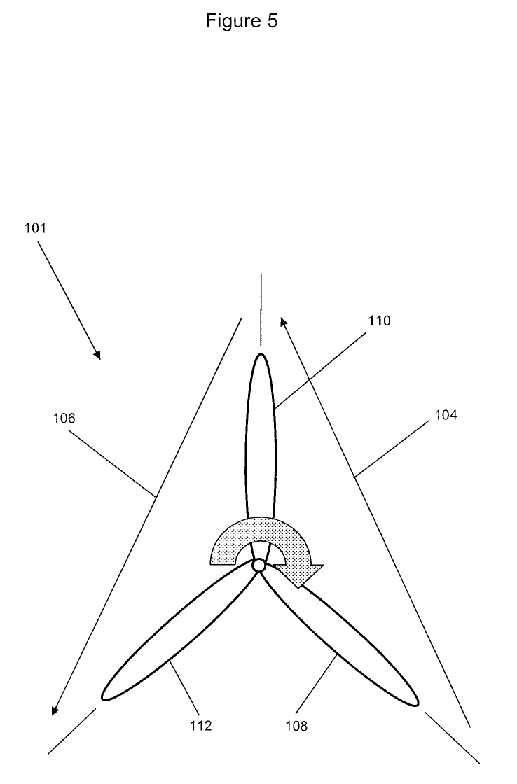

The principles taught herein regarding multi-stage wind turbine 1 may be applied to multi-mode wind turbine 101, as depicted in FIGS. 4 and 5. FIG. 4 depicts a front view of multi-mode wind turbine 101 in a single virtual blade mode. It is commonly know that a single blade wind turbine is highly efficient, with a high speed low torque characteristic. Multi-mode wind turbine 101 may achieve and optimize this level of efficiency by optimizing the aerodynamics of single virtual blade 102 for a given set of wind conditions. This may be accomplished by adjusting primary angular displacement 104 and secondary angular displacement 106, as required and as previously described. The combined aerodynamics of single virtual blade 102 may be further changed and optimized by adjusting the axial displacements (not shown) between upstream blade 108, middle blade 110, and downstream blade 112, as previously described.

One of the drawbacks of a single blade wind turbine is an inherent lack of balance. This may be at least partially addressed in multi-mode wind turbine 101 by configuring counter-balances 114a, 114b and 114c to rotate with upstream blade 108, middle blade 110, and downstream blade 112, respectively, at an angular displacement of one hundred and eighty (180) degrees. Counterbalances 114a, 114b and 114c may be further configured to constructively contribute to the combined aerodynamics of single virtual blade 102.

FIG. 5 depicts multi-mode wind turbine 101 in a three blade mode. In this case upstream blade 108 has been rotated with respect to middle blade 110 such that primary angular displacement 104 is now one hundred and twenty (120) degrees, and downstream blade 112 has been rotated with respect to middle blade 110 such that secondary angular displacement 106 is also one hundred and twenty (120) degrees. This matches the geometry of a traditional three blade turbine, except that upstream blade 108, middle blade 110, and downstream blade 112 may be separated by some axial displacement (not shown). However this axial displacement may be minimized, by allowing the hub of a downstream blade to nest within and become much closer to the hub of the next upstream blade when the correct alignment has been achieved, or through some other means, if required to optimize the three blade mode performance.

Multi-mode wind turbine 101 may be configured to change between the single virtual blade and three blade modes using a three shaft/three brake version of the braking system configured for multi-stage wind turbine 1 (reference FIG. 2), as previously described, or through some other means. Further, the three shafts may be configured with adjustable alignment stops to aid in the correct alignment of upstream blade 108, middle blade 110, and downstream blade 112 at one hundred and twenty (120) degree intervals.

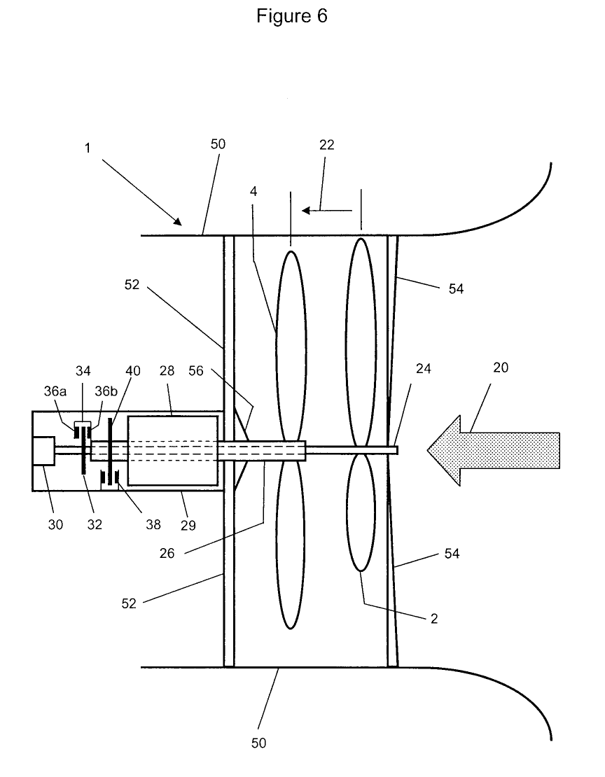

FIG. 6 presents a side view of multi-stage wind turbine 1 with aerodynamic shroud 50. Aerodynamic shroud 50 may be configured as a large scale nozzle, serving to accelerate the wind as it passes through the rotating blades of multi-stage wind turbine 1, thereby allowing multi-stage wind turbine 1 to produce more torque. It should be noted that multi-stage wind turbine 1 is shown here for illustrative purposes, and that the principles taught herein regarding aerodynamic shroud 50 may also be applied to multi-mode wind turbine 101 (reference FIG. 4) as well as several types of traditional wind turbines.

Aerodynamic shroud 50 may be configured with support struts 52 and stator struts 54. Support struts 52 may be configured to bear the main load of aerodynamic 50, to act as a heat sink for components contained within generator housing 29, and further to be integrated with nose cone 56 in order to improve the aerodynamics around generator housing 29. Stator struts 54 may be configured to improve the inlet conditions for upstream rotor 2 and downstream rotor 4, thereby allowing them to extract more net energy from the wind. Stator struts 54 may also be configured to include an additional outboard bearing for inner shaft 24, providing support while still allowing inner shaft 24 to move upstream or downstream, to facilitate changes in axial displacement 22. In certain applications stator strut 54 may alternatively be configured between upstream rotor 2 and downstream rotor 4, serving to reduce the swirl induced by upstream rotor 2 before the wind enters downstream rotor 4.

Aerodynamic shroud 50 may also be configured to contain the blades of upstream rotor 2 and downstream rotor 4 in the event of a blade detachment, thereby contributing to the safety of multi-stage wind turbine 1. Further, aerodynamic shroud 50 may be configured to reduce the acoustic noise produced by multi-stage wind turbine 1, for example by reducing the clearance between the rotating blade tips and aerodynamic shroud 50, or through some other means. Further, aerodynamic shroud 50, the blades on upstream rotor 2, and the blades on downstream rotor 4 may together be configured to function as a generator, with magnets on the rotating blade tips inducing current in selectively operational poles located around the inside perimeter of aerodynamic shroud 50. This type of generator, when connected to an excessive load, could also be used as a type of brake for upstream rotor 2 and downstream rotor 4.

In an alternative configuration aerodynamic shroud 50, upstream rotor 2, and downstream rotor 4 may be reversed such that multi-stage wind turbine 1 is adapted to produce torque when wind 20 flows in the opposite direction. In this case generator housing 29 would be upstream of the rotors, and hence may be configured with cones, vanes, or other dynamic features that will accelerate the wind induced airflow and/or otherwise improve the inlet conditions for the rotors.

The above-noted examples and exemplifications of the invention are not meant to be limiting, and are merely examples of the invention embodied by the claims described below. All patents and applications described herein are hereby incorporated by reference.

1. A wind turbine blade assembly for a wind turbine, comprising:
a. a front rotor having at least one front blade;
b. a rear rotor having at least one rear blade;
wherein an angular displacement between the front blade and the rear blade is adjustable, and the front rotor and the rear rotor are configured to rotate in the same direction when the wind turbine is in operation.

2. The wind turbine blade assembly of claim 1 wherein the angular displacement between the front blade and the rear blade is adjustable between an angle of −15 degrees and an angle of +15 degrees.

3. The wind turbine blade assembly of claim 1 or claim 2 wherein the angular displacement between the front blade and the rear blade is adjustable while the wind turbine is in operation.

4. The wind turbine blade assembly of any one of claims 1-3, wherein an axial displacement between the front blade and the rear blade is adjustable.

5. A wind turbine blade assembly for a wind turbine, comprising:
a. a front rotor having at least one front blade;
b. a rear rotor having at least one rear blade;
wherein an axial displacement between the front blade and the rear blade is adjustable, and the front rotor and the rear rotor are configured to rotate in the same direction when the wind turbine is in operation.

6. The wind turbine blade assembly of any one of claims 4 or 5 wherein the axial displacement is adjustable by 10% of the rotor diameter.

7. The wind turbine blade assembly of claim 4 or 5 wherein the axial displacement is adjustable while the wind turbine is in operation.

8. The wind turbine blade assembly of any one of claims 1 to 7 wherein the front rotor has three front blades mounted at 120 degree intervals, and the rear rotor has three rear blades mounted at 120 degree intervals.

9. The wind turbine blade assembly of any one of claims 1 to 7 further comprising an intermediate rotor having at least one intermediate blade, wherein the front rotor and the intermediate rotor are configured to rotate in the same direction when the wind turbine is in operation.

10. The wind turbine blade assembly of claim 9, wherein an intermediate angular displacement between the front blade and the intermediate blade is adjustable.

11. The wind turbine blade assembly of claim 9 or claim 10, wherein an intermediate axial displacement between the front blade and the intermediate blade is adjustable.

12. The wind turbine blade assembly of claim 10 wherein the intermediate angular displacement between the front blade and the intermediate blade is adjustable between an angle of −15 degrees and an angle of +15 degrees.

13. The wind turbine blade assembly of claim 10 wherein the intermediate angular displacement between the front blade and the intermediate blade is adjustable while the wind turbine is in operation.

14. The wind turbine blade assembly of claim 11, wherein the intermediate axial displacement is adjustable by 10% of the rotor diameter.

15. The wind turbine blade assembly of claim 11 wherein the intermediate axial displacement is adjustable while the wind turbine is in operation.

16. The wind turbine blade assembly of claim 1 further comprising a front counter-ballast located on the front rotor at 180 degrees to the front blade.

17. The wind turbine blade assembly of claim 1 further comprising a rear counter-ballast located on the rear rotor at 180 degrees to the rear blade.

18. The wind turbine blade assembly of claim 9, further comprising an intermediate counter-ballast located on the intermediate rotor at 180 degrees to the intermediate blade.

19. The wind turbine blade assembly of claim 4 wherein the angular displacement and the axial displacement between the front blade and the rear blade can be adjusted such that both approach 0 and the front blade and the rear blade have a combined aerodynamic effect of a single blade.

20. The wind turbine blade assembly of claim 13 wherein the angular displacement and the axial displacement between the front blade, the rear blade, and the intermediate blade, can be adjusted such that they all approach 0 and the front blade, the rear blade, and the intermediate blade have a combined aerodynamic effect of a single blade.

21. The wind turbine blade assembly of claim 13 wherein the angular displacement between the front blade, the rear blade, and the intermediate blade, can be adjusted such that they all approach 120 degrees, and the front blade, the rear blade, and the intermediate blade have a combined aerodynamic effect of a three blade, single rotor blade assembly.

22. A wind turbine having the wind turbine blade assembly of any one of claims 1-21.

23. The wind turbine of claim 22 wherein the front rotor is mounted on an inner shaft and the rear rotor is mounted on an outer shaft, wherein the inner shaft and the outer shaft are co-axial such that the inner shaft and the outer shaft can be rotated with respect to one another.

24. The wind turbine of claim 22 further comprising:
a. an adjustable hub, that allows the front rotor to be rotated with respect to the rear rotor or the rear rotor to be rotated with respect to the front rotor;
b. a brake system, that allows the adjustable hub to be affixed in position such that the front rotor and the rear rotor do not rotate with respect to one another.

25. The wind turbine of claim 23 further comprising a linear actuator affixed to a distal end of the inner shaft, wherein the linear actuator is configured to push the inner shaft and front rotor to increase axial displacement between the front rotor and the back rotor, and to pull the inner shaft and front rotor to decrease axial displacement between the front rotor and the back rotor.

26. The wind turbine of claim 23 further comprising a shaft brake attached to the inner shaft, said shaft brake, when activated, allowing the inner shaft to be in locked rotation with the outer shaft, and, when released, allowing the inner shaft to rotate freely from said outer shaft.

27. The wind turbine of claim 26 further comprising a position sensor capable of monitoring the relative rotational position of the inner shaft with respect to the outer shaft to facilitate control of angular displacement.

28. The wind turbine of any one of claims 22-27 further comprising an aerodynamic shroud.

29. The wind turbine of claim 28 wherein the aerodynamic shroud is configured as a large scale nozzle.

30. The wind turbine of claim 28 wherein the aerodynamic shroud comprises a nose cone, at least one support strut and at least one stator strut, said support strut configured to be integrated with said nose cone.

31. The wind turbine of claim 28 wherein the aerodynamic shroud is configured to contain the blades in the event of a blade detachment.

32. The wind turbine of claim 28 wherein the blades are configured with permanent magnets and the aerodynamic shroud is configured with multiple generator poles, wherein the generator poles are selectively responsive to the rotation of the blades to generate electrical current.

33. The wind turbine of claim 22 wherein the axial and angular displacements are pre-set for an average wind condition.

34. The wind turbine of claim 25 further comprising a set of splines or a set of cams, configured to create a fixed set of angular and axial displacement parameters.
